(19) United States
(12) Patent Application Publication
(10) Pub. No.: US 2012/0315546 A1
(43) Pub. Date: Dec. 13, 2012

(54) LITHIUM ION BATTERY

(75) Inventors: Shinako Kaneko, Sendai-shi (JP); Hitoshi Ishikawa, Sendai-shi (JP); Yasutaka Kono, Sendai-shi (JP); Yoko Hashizume, Sendai-shi (JP); Hiroshi Kobayashi, Sendai-shi (JP)

(73) Assignee: NEC TOKIN CORPORATION, Sendai-shi (JP)

(21) Appl. No.: 13/584,719

(22) Filed: Aug. 13, 2012

Related U.S. Application Data
(63) Continuation of application No. 12/552,449, filed on Sep. 2, 2009, now abandoned.

(30) Foreign Application Priority Data
Oct. 14, 2008 (JP) 2008-264854

(51) Int. Cl. H01M 10/056

(52) U.S. Cl. 429/303; 429/199

(57) ABSTRACT

To provide high energy density, good cycle properties and rate characteristics and long-term safety of a lithium ion battery containing at least an ionic liquid and a lithium salt. The above problems are solved by suppressing reduction and decomposition of the ionic liquid on an anode by using a graphite coated with an amorphous carbon or onto which an amorphous carbon is deposited as an anode active material.

### BACKGROUND OF THE INVENTION

1. Field of the Invention

The present invention relates to a lithium ion battery with high safety.

2. Description of the Related Art

Lithium ion batteries can provide high energy densities and therefore are attracting attention as power supplies for mobile phones and notebook computers and also as large-scale power supplies for electric power storage and power supplies for automobiles.

Although lithium ion batteries can offer high energy density, their increasing size gives rise to an enormous amount of energy and requires higher safety. For example, large-scale power supplies for electric power storage and power supplies for automobiles require particularly high safety, and their safety is sufficiently considered and ensured with measures including structural designs of cells and packages, protection circuits, electrode materials, additives having a function of preventing overcharge and enhanced shutdown functions of separators; and one means for further increasing safety is to make electrolyte flame resistant.

Lithium ion batteries use an aprotic solvent such as cyclic carbonate or linear carbonate as an electrolyte solvent, and such carbonates have a characteristic of high dielectric constant and high ionic conductivity for lithium ions but being flammable due to a low flash point. Generally cyclic carbonates have a high dielectric constant and a high viscosity while linear carbonates have a low dielectric constant and a low viscosity. Therefore, in lithium ion batteries, those solvents are used in a mixture depending on the applications.

On the other hand, there are studies on the use of ionic liquid that is liquid at a certain temperature as an electrolyte solvent. Since ionic liquid has the characteristic of being extremely inflammable because of its non-volatility and high decomposition temperatures, studies are actively made on the use of ionic liquid as an electrolyte of lithium ion batteries.

In Japanese Patent No. 3426869, an ionic liquid containing 1-methyl-3-ethylimidazolium cations is used as an electrolyte solvent. The electrolyte solvent shows good properties as it does not evaporate even in a high temperature environment of 120° C. However, ionic liquid containing such cations has poor reduction stability and is reduced and decomposed by Li/Li⁺ at a potential of 1 V or lower. For that reason, a disadvantage when an anode acts on Li/Li⁺ at 1 V or lower is a significant decrease in cycle characteristics of batteries. Therefore, it is necessary to use an anode active material that makes the operating potential of the anode on Li/Li⁺1 V or higher, and in such cases, high energy density cannot be offered because the voltage of the battery is lower than that in the case of using a carbon anode.

Japanese Patent Application Laid-Open No. 2003-331918 discloses that an ionic liquid composed of at least a cation selected from the group consisting of N-methyl-N-ethylpyrrolidinium, N-methyl-N-propylpyrrolidinium, N-methyl-N-ethylpyrrolidinium and N-methyl-N-propylpiperidinium has excellent reduction stability even at an operating potential of Li metal or Sn on Li/Li⁺ of 1 V or lower, and that a battery in which an anode is made from Li metal and a cathode is made from LiCoO₂ has high energy density, excellent storage characteristics and flame retardancy.

Japanese Patent Application Laid-Open No. 2007-207675 discloses a lithium secondary battery of 4 V level using an ionic liquid containing bis(fluorosulfonyl)imide anion, in which an anode active material such as graphite, zinc oxide or a Si material such as SiO₂, which allows Li to be inserted or released at a potential close to the oxidation-reduction potential of Li metal, is used.

Also, J. Power Sources vol. 162 (2006) pp. 658-662 shows that an ionic liquid composed of bis(fluorosulfonyl)imide anion makes insertion and release of Li ions on graphite possible.

However, Japanese Patent Application Laid-Open No. 2007-207675 and J. Power Sources vol. 162 (2006) pp. 658-662 only describe that charge and discharge become possible when using graphite, and do not describe graphite coated with amorphous carbon or onto which amorphous carbon is deposited. For their practical use, reduction and decomposition of ionic liquid on graphite remains a problem.

On the other hand, carbon materials are commonly used as an anode material in lithium ion batteries, and it is known that on the surface of such carbon, carbonate such as propylene carbonate, which is an electrolyte solvent, is reduced and decomposed by Li/Li⁺ at around 1 V, resulting in an increase in irreversible capacity and a decrease in charge/discharge efficiency or cycle characteristics. In particular, it is known that on the surface of carbon with a high degree of graphitization, cyclic carbonate such as PC (propylene carbonate) is easily decomposed, causing a decrease in cycle characteristics.

Generally, ionic liquid has a high viscosity and therefore has a disadvantage of poor impregnation into porous materials such as electrodes and separators. To improve the impregnation of ionic liquid into porous materials, techniques of lowering the viscosity by mixing carbonate are studied as in Japanese Patent No. 3774315 and Japanese Patent Application Laid-Open No. 2003-288939. Japanese Patent No. 3774315 describes mixing of 0.1 to 30% by volume of cyclic carbonate and/or linear carbonate and Japanese Patent Application Laid-Open No. 2003-288939 describes mixing of 50% by volume or more. The documents have proved that mixing of cyclic carbonate and/or linear carbonate having a viscosity lower than that of ionic liquid decreases the viscosity of electrolyte solvent, improves the impregnation into porous materials such as electrodes and separators, and increases the energy density. However, such cyclic carbonate has poor reduction stability and is easily reduced and decomposed particularly on the surface of graphite carbon. For that reason, unfortunately, carbonate is reduced and decomposed on the surface of graphite with repeated cycles, resulting in a significant decrease in cycle characteristics and storage characteristics. Also, a problem of the use of ionic liquid with poor reduction stability is that ionic liquid is reduced and decomposed with repeated cycles, resulting in significant decrease in battery characteristics.

A technique that uses, as an additive, a substance which is reduced and decomposed at a potential higher than carbonates used as an electrolyte solvent and forms a protective film having high lithium ion permeability, i.e., a solid electrolyte interface (SEI), is known. It is known that since such a protective film has a great impact on charge/discharge efficiency, cycle characteristics and safety, control of the protective film is essential for increasing the performance of anodes, and carbon materials and oxide materials require a lowered irreversible capacity.

Under such circumstances, it has been shown that addition of an additive for forming a protective film on the surface of graphite carbon makes it possible to reduce the irreversible capacity and improve the capacity and cycle characteristics with maintaining the flame retardancy of electrolyte, and the following techniques using graphite carbon are published. It is described that the above improvement has been made when cyclic ester containing a π bond, such as vinylene carbonate, is included as in Japanese Patent Application Laid-Open No. 2002-373704, a cyclic organic compound containing a S═O bond, such as 1,3-propanesulton as in Japanese Patent Application Laid-Open No. 2005-026091, cyclic carbonate containing a C═C unsaturated bond, such as vinyl ethylene carbonate as in Japanese Patent Application Laid-Open No. 2006-085912, and a cyclic organic compound containing a S═O bond, such as 1,3-propanesulton and/or cyclic carbonate containing a π bond, such as vinylene carbonate as in Japanese Patent Application Laid-Open No. 2007-134282.

However, since graphite has an extremely high activity in decomposing an electrolyte, it is necessary to add a large amount of a substance for forming a protective film, which is described in Japanese Patent Application Laid-Open No. 2002-373704, Japanese Patent Application Laid-Open No. 2005-026091, Japanese Patent Application Laid-Open No. 2006-085912 or Japanese Patent Application Laid-Open No. 2007-134282, in order to form a protective film that offers good properties for long periods. Problems of the use of a large amount of an additive involve a decrease in battery characteristics and a decrease in charge/discharge efficiency due to increased resistance values and increased irreversible capacities. Also, Japanese Patent Application Laid-Open No. 2008-108460 discloses a technique concerning an anode active material composed of a carbon material (non-graphitizable carbon) in which the spacing of (002) planes is 0.34 nm or more; although such non-graphitizable carbon is unlikely to cause decomposition of solvent molecules, the material itself has a large irreversible capacity and a smaller capacity than graphite carbon, and therefore has a disadvantage of poorer volumetric efficiency compared to using graphite as an anode active material.

To ensure good battery characteristics, prevention of reduction and decomposition of ionic liquid is very important. When using an anode of graphite carbon in a lithium ion battery using ionic liquid, charge/discharge became possible by limiting anion species of ionic liquid to bis(fluorosulfonyl)imide anion. However problems are a large irreversible capacity due to the occurrence of decomposition reaction on the surface of graphite carbon which has a high reduction/decomposition activity, and a decrease in cycle characteristics due to reduction and decomposition.

Another problem is that because intercalation of lithium ions into graphite carbon in ionic liquid containing bis(fluorosulfonyl)imide anion is susceptible to overvoltage and produces large resistance compared to intercalation in an aprotic solvent, the resulting battery has poor rate characteristics.

It has also been found that electrolyte or gel electrolyte composed of ionic liquid that has undergone reduction and decomposition, which is the problem described above, has lower flame retardancy. More specifically, once ionic liquid is reduced and decomposed, their initial non-volatility and inflammability cannot be maintained. The problem is that since ionic liquid is easily reduced and decomposed on the surface of graphite carbon, safety is lowered when cycles are repeated.

The present invention has been made in view of the above-described problems. An object of the present invention is to provide a lithium ion battery having high energy density and improved charge/discharge cycle characteristics, high-temperature storage characteristics and rate characteristics with maintaining the flame retardancy of electrolyte over long periods.

### SUMMARY OF THE INVENTION

Under such circumstances, intensive studies have been conducted and as a result, it has been found that the above problems can be solved by using graphite particles whose surface is coated with amorphous carbon or onto the surface of which amorphous carbon is deposited as an anode active material. Specifically, the present invention solves the above problems with a lithium ion battery using an electrolyte containing at least an ionic liquid and a lithium salt and an anode active material composed of graphite particles whose surface is coated with amorphous carbon or onto the surface of which amorphous carbon is deposited.

The present invention is characterized in that to suppress the reduction/decomposition activity of graphite and to facilitate the intercalation of lithium ions into graphite carbon in an electrolyte containing at least an ionic liquid or a gel electrolyte gelled by polymer, the amorphous carbon with which the surface of graphite particles is coated or which is deposited thereonto has an amount of 1% by mass or more to 30% by mass or less based on the anode active material.

The present invention is characterized in that although the same advantage can be offered regardless of whether the graphite particles are of artificial or natural graphite, the graphite particles are preferably of natural graphite, and/or that the graphite particles have an interlayer distance between (002) planes of 0.335 to 0.337 nm and/or a specific surface area of 1.0 to 1.8 m²/g.

In another aspect of the present invention, a common additive for electrolyte may be further used so as to suppress reduction and decomposition; more preferably the electrolyte contains disulfonic acid ester, or vinylene carbonate or a derivative thereof.

Generally, since ionic liquid is reduced and decomposed at the surface of graphite particles, its irreversible capacity is large. However, the present invention makes it possible to suppress reduction and decomposition of ionic liquid by coating the surface of graphite particles with amorphous carbon or depositing amorphous carbon thereonto, and thus the irreversible capacity can be decreased. As a result, the capacity of a battery can be increased and a battery with high energy density can be produced.

The present invention makes it possible to suppress reduction and decomposition of ionic liquid by coating the surface of graphite particles with amorphous carbon or depositing amorphous carbon thereonto, improve battery characteristics such as long term cycle properties, and produce a battery with good characteristics.

In the present invention, the amount of the amorphous carbon with which the surface of graphite particles is coated or which is deposited thereonto is 30% by mass or less based on the anode active material; using too much amorphous carbon is not preferred because the capacity based on the anode active material is decreased. On the other hand, when the amount of the amorphous carbon is less than 1% by mass, the reduction/decomposition reaction on the graphite particles cannot be sufficiently suppressed. Accordingly, a battery with superior characteristics such as long term cycle properties can be produced when the amount is 1% by mass or more to 30% by mass or less.

Also, the intercalation of lithium ions in ionic liquid occurs energetically more advantageously on the surface of amorphous carbon than on the surface of graphite particles, and therefore the resistance can be decreased and a battery with superior rate characteristics can be produced.

Furthermore, since the reduction and decomposition of ionic liquid can be suppressed for the reason mentioned above, the flame retardancy of electrolyte or gel electrolyte can be maintained for long periods, offering a battery with high safety.

### BRIEF DESCRIPTION OF THE DRAWINGS

FIG. 1 illustrates the structure of the cathode of the lithium ion battery of Example 1 of the present invention;

FIG. 2 illustrates the structure of the anode of the lithium ion battery of Example 1 of the present invention; and

FIG. 3 illustrates a configuration after winding of battery elements of the lithium ion battery of Example 1 of the present invention.

### DETAILED DESCRIPTION OF THE PREFERRED EMBODIMENTS

Embodiments of the present invention are described below.

In the lithium ion battery of the present invention, a graphite coated with amorphous carbon or onto which an amorphous carbon is deposited is used as an anode active material; lithium-storing graphite, both artificial graphite and natural graphite, may be used as graphite, and natural graphite is particularly preferred.

Graphite may be laminar, massive, fibrous, spherical or flaky, and any of these forms may be used.

Also, amorphous carbon may coat the whole or part of graphite.

Examples of methods of coating amorphous carbon include, but are not limited to, a method in which the surface of graphite particles is coated with a condensed polycyclic hydrocarbon compound such as paraffin, olefin or an aromatic compound or an organic polymer compound such as phenolic resin, acrylic resin or polyvinyl chloride and the resultant is made into amorphous carbon by heat treatment and a method in which an organic compound is thermally decomposed into gas and adsorbed to the surface of graphite particles. Methods of coating amorphous carbon are, for example, disclosed in Japanese Patent Nos. 333536 and 3711726.

In the battery of the present invention, examples of cathode active materials include lithium-containing complex oxide such as LiCoO₂, LiNiO₂ and LiMn₂O₄. Such lithium-containing complex oxide whose transition metal part is substituted with another element may also be used.

A lithium-containing complex oxide having a plateau at a potential of the metal lithium counter electrode of 4.5 V or higher may also be used. Examples of lithium-containing complex oxides include spinel lithium manganese complex oxides, olivine lithium-containing complex oxides and inverse spinel lithium-containing complex oxides. Such a lithium-containing complex oxide may be, for example, a compound represented by Liₐ(MₓMn₂₋ₓ)O₄ (in which 0<x<2 and 0<a<1.2; M is at least one member selected from the group consisting of Ni, Co, Fe, Cr and Cu).

The battery of the present invention can be produced by dispersing and kneading each of an anode active material and a cathode active material with a conductive auxiliary agent such as carbon black and a binder such as polyvinylidene fluoride (PVDF) in a solvent such as N-methyl-2-pyrrolidone (NMP) and applying the mixture to a substrate such as copper foil for an anode active material and aluminum foil for a cathode active material.

In the battery of the present invention, the electrolyte contains at least bis(fluorosulfonyl)imide anion.

Examples of other anions contained in the electrolyte according to the present invention include, but are not limited to, PF₆⁻, PF₃(C₂F₅)₃⁻, PF₃(CF₃)₃⁻, BF₄⁻. BF₂(CF₃)₂⁻, BF₃(CF₃)₂⁻, AlCl₄⁻, N(CF₃SO₂)₂⁻, N(C₂F₅SO₂)₂⁻, and CF₃SO₃⁻

Examples of cation species for the ionic liquid according to the present invention include quaternary ammonium cations, phosphonium cations and sulfonium cations. Examples of cations composed of an ammonium cation include, but are not limited to, N-methyl-N-propylpyrrolidinium, N-methyl-N-butylpyrrolidinium, N-methyl-N-propylpiperidinium, N-methyl-N-butylpiperidinium, tetraethylammonium, triethylmethylammonium, N,N,N-trimethyl-N-propylammonium, 1-butyl-3-methylimidazolium, 1-ethyl-3-methylimidazolium, 1-hexyl-3-methylimidazolium, 1-octyl-3-methylimidazolium, 1-ethyl-2,3-dimethylimidazolium, 1-butyl-2,3-dimethylimidazolium, 1-hexyl-2,3-dimethylimidazolium, 1-ethylpyridinium, 1-butylpyridinium and 1-hexylpyridinium. Examples of cations composed of a phosphonium cation include, but are not limited to, tributyl-n-octylphosphonium, tetraphenylphosphonium, tetraethylphosphonium, tetra-n-octylphosphonium, methyltriphenylphosphonium, isopropyltriphenylphosphonium, methoxycarbonylmethyl (triphenyl)phosphonium, ethyltriphenylphosphonium, butyltriphenylphosphonium and (1-naphthylmethyl)triphenylphosphonium. Examples of cations composed of a sulfonium cation include, but are not limited to, trimethylsulfonium, (2-carboxyethyl)dimethylsulfonium, diphenyl(methyl)sulfonium, tri-n-butyl sulfonium, tri-p-tolyl sulfonium, triphenyl sulfonium and cyclopropyldiphenylsulfonium.

Examples of polymer components contained in the gel electrolyte according to the present invention include a monomer, an oligomer or a copolymerization oligomer containing two or more thermally polymerizable group per molecule. Examples of such gelling components include substances that form an acrylic polymer, such as difunctional acrylate including ethylene glycol diacrylate, diethylene glycol diacrylate, triethylene glycol diacrylate, tetraethylene glycol diacrylate, propylene diacrylate, dipropylene diacrylate, tripropylene diacrylate, 1,3-butanediol diacrylate, 1,4-butanediol diacrylate and 1,6-hexanediol diacrylate, trifunctional acrylate including trimethylolpropane triacrylate and pentaerythritol triacrylate, tetrafunctional acrylates including ditrimethylolpropane tetraacrylate and pentaerythritol tetraacrylate and the above-described methacrylate monomers. In addition to them, examples thereof include, but are not limited to, monomers such as urethane acrylate and urethane methacrylate, copolymerization oligomers thereof and copolymerization oligomers with acrylonitrile.

Polymers that can be dissolved in a plasticizer and cause gelation, such as polyvinylidene fluoride, polyethylene oxide and polyacrylonitrile may also be used.

The polymer component is not limited to the monomers, oligomers or polymers described above, and any substance may be used as long as it causes gelation. Such gelling components are not limited to a single monomer, oligomer or polymer, and a few types of gelling components may be used in a mixture according to need.

Also, thermal polymerization initiators such as benzoins and peroxides may be used, which are not limited thereto.

Disulfonic acid ester contained in the electrolyte according to the present invention may be a compound represented by the following formula 1 or 2.

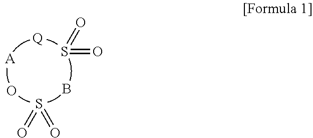

In the formula 1, Q represents an oxygen atom, a methylene group or a single bond, A represents an alkylene group, which may be branched, substituted or non-substituted and contains 1 to 5 carbon atoms, a carbonyl group, a sulfinyl group, a perfluoroalkylene group which may be branched, substituted or non-substituted and contains 1 to 5 carbon atoms, a fluoroalkylene group which may be branched, substituted or non-substituted and contains 2 to 6 carbon atoms, an alkylene group which contains an ether bond, may be branched, substituted or non-substituted and contains 1 to 6 carbon atoms, a perfluoroalkylene group which contains an ether bond, may be branched, substituted or non-substituted and contains 1 to 6 carbon atoms or a fluoroalkylene group which contains an ether bond, may be branched, substituted or non-substituted and contains 2 to 6 carbon atoms. B represents an alkylene group which may be branched and substituted or non-substituted.

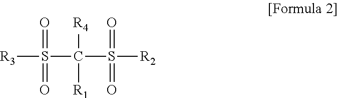

In the formula 2, R₁ and R₄ each independently represent an atom or a group selected from a hydrogen atom, a substituted or non-substituted alkyl group containing 1 to 5 carbon atoms, a substituted or non-substituted alkoxy group containing 1 to 5 carbon atoms, a substituted or non-substituted fluoroalkyl group containing 1 to 5 carbon atoms, a polyfluoroalkyl group containing 1 to 5 carbon atoms, —SO₂X₁ (in which X₁ is a substituted or non-substituted alkyl group containing 1 to 5 carbon atoms), —SY₁ (in which Y₁ is a substituted or non-substituted alkyl group containing 1 to 5 carbon atoms), —COZ (in which Z is a hydrogen atom or a substituted or non-substituted alkyl group containing 1 to 5 carbon atoms) and a halogen atom. R₂ and R₃ each independently represent an atom or a group selected from a substituted or non-substituted alkyl group containing 1 to 5 carbon atoms, a substituted or non-substituted alkoxy group containing 1 to 5 carbon atoms, a substituted or non-substituted phenoxy group, a substituted or non-substituted fluoroalkyl group containing 1 to 5 carbon atoms, a polyfluoroalkyl group containing 1 to 5 carbon atoms, a substituted or non-substituted fluoroalkoxy group containing 1 to 5 carbon atoms, a polyfluoroalkoxy group containing 1 to 5 carbon atoms, a hydroxyl group, a halogen atom, —NX₂X₃ (in which X₂ and X₃ are each independently a hydrogen atom or a substituted or non-substituted alkyl group containing 1 to 5 carbon atoms) and —NY₂CONY₃Y₄ (in which Y₂ to Y₄ are each independently a hydrogen atom or a substituted or non-substituted alkyl group containing 1 to 5 carbon atoms).

Typical examples of compounds represented by the above formula 1 are described in Table 1 and typical examples of compounds represented by the above formula 2 are described in Table 2, but the present invention is not limited thereto.

TABLE 1

| Compound | Chemical |
|---|---|
| No. | structure |
| 1 | 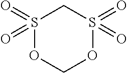 |
| 2 | 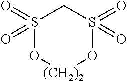 |
| 3 | 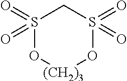 |
| 4 | 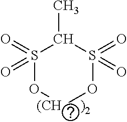 |
| 5 | 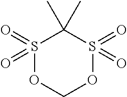 |
| 6 | 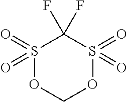 |
| 7 | 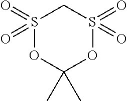 |
| 8 | 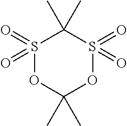 |
| 9 | 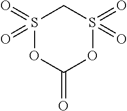 |
| 10 | 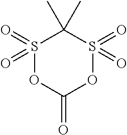 |
| 11 | 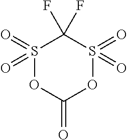 |
| 12 | 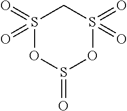 |
| 13 | 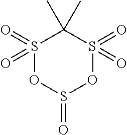 |
| 14 | 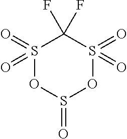 |
| 15 | 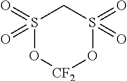 |
| 16 | 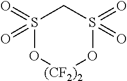 |
| 17 | 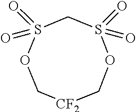 |
| 18 | 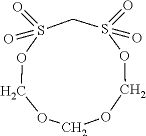 |
| 19 | 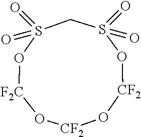 |
| 20 | 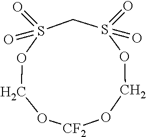 |
| 21 | 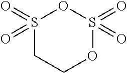 |
| 22 | 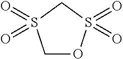 |

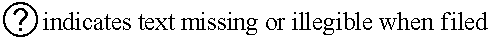

TABLE 2

| Compound | Chemical |
|---|---|
| No. | structure |
| 101 | 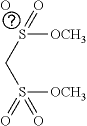 |
| 102 | 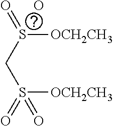 |
| 103 | 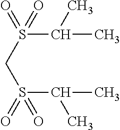 |
| 104 | 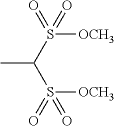 |
| 105 | 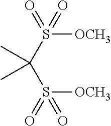 |
| 106 | 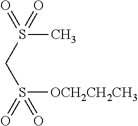 |
| 107 | 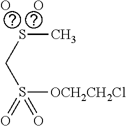 |
| 108 | 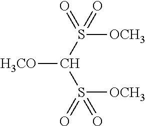 |
| 109 | 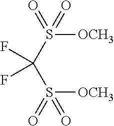 |
| 110 | 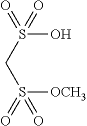 |
| 111 | 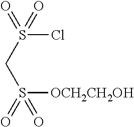 |
| 112 | 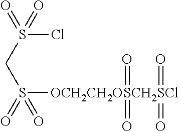 |
| 113 | 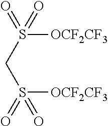 |
| 114 | 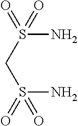 |
| 115 | 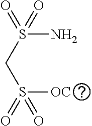 |
| 116 | 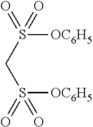 |
| 117 | 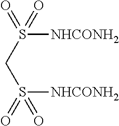 |
| 118 | 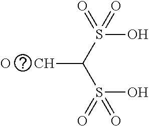 |
| 119 | 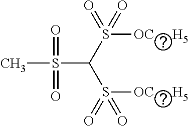 |
| 120 | 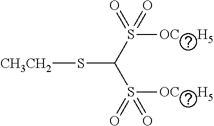 |

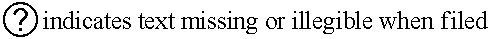

Compounds represented by the above formula 1 or 2 can be produced by the process described in Japanese Examined Patent Publication No. 5-44946.

Although the percentage of the compound represented by the formula 1 or 2 in electrolyte is not particularly defined, the percentage is preferably 0.005 to 20% by mass based on the total electrolyte. When the concentration of the compound represented by the formula 1 or 2 is 0.005% by mass or more, the advantage of the surface film is satisfactory. More preferably, when 0.01% by mass or more of the compound is added, battery characteristics can be further improved. Also, when the percentage is 20% by mass or less, increase in the viscosity of electrolyte and the resulting increase in resistance can be suppressed. More preferably, when 5% by mass or less of the compound is added, battery characteristics can be further improved.

Moreover, vinylene carbonate or a derivative thereof may be used for the battery of the present invention according to need. The concentration of vinylene carbonate contained is preferably 0.1% by mass or more to 10% by mass or less, particularly preferably 0.1% by mass or more to 5% by mass or less.

For the separator of the battery according to the present invention, nonwoven fabric, polyolefin microporous film, porous film into which particles such as Si are dispersed and hydrophilized polyolefin microporous film, which are commonly used for lithium polymer batteries, may be used.

For producing the battery of the present invention, an anode and a cathode are laminated with a porous separator being interposed therebetween, or they are laminated and wound, and then housed in a battery can or an outer package of flexible film composed of a laminate of a synthetic resin and metal foil, and the resultant is impregnated with an electrolyte containing the compound represented by the above formula 1 and ionic liquid. Then the outer package is sealed, or by charging after sealing, a surface film can be formed on the anode. As the porous separator, a porous film of polyolefin such as polypropylene or polyethylene or a fluorine resin is used.

Shapes of the lithium ion or lithium polymer battery according to the present embodiment include, but are not particularly limited to, a cylindrical type, a rectangular type, a laminate package type and a coin type. In the laminate package type, in particular, electrodes may be a winding type or a lamination type.

### EXAMPLES

The present invention is described in detail by means of Examples with reference to the figures, but the present invention is not limited to these Examples.

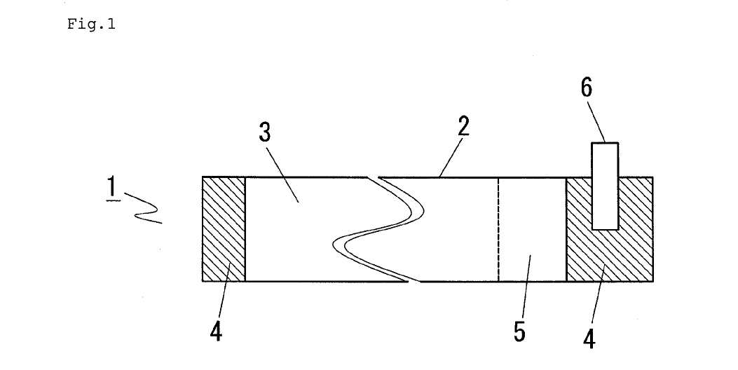

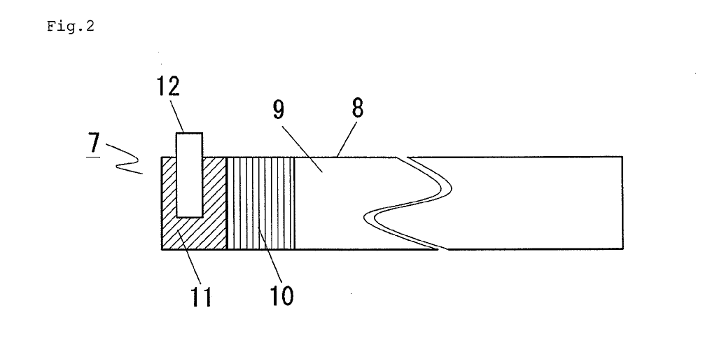

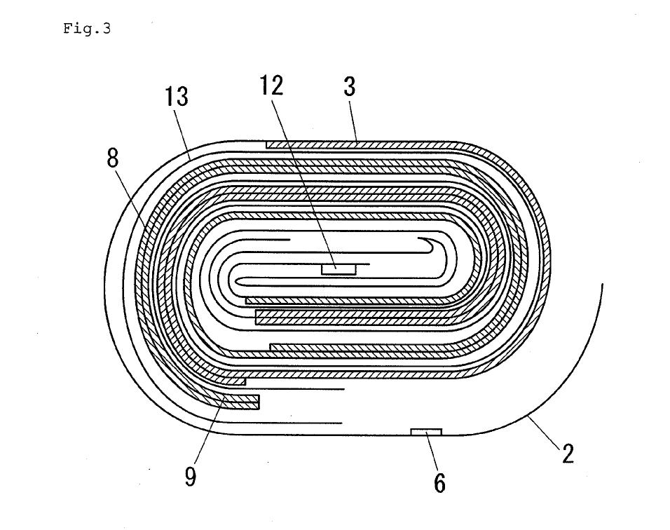

FIG. 1 illustrates the structure of the cathode of the lithium ion battery of Example 1 of the present invention; FIG. 2 illustrates the structure of the anode of the lithium ion battery of Example 1 of the present invention; and FIG. 3 is a cross-sectional view illustrating a configuration after winding of battery elements of the lithium ion battery of Example 1 of the present invention.

### Example 1

First, preparation of a cathode is described with reference to FIG. 1. A cathode slurry was prepared by adding N-methylpyrrolidone to a mixture prepared by mixing 85% by mass of LiMn₂O₄, 7% by mass of acetylene black which is a conductive auxiliary agent and 8% by mass of polyvinylidene fluoride which is a binder and further mixing the mixture. The slurry was applied to both sides of 20 μm-thick Al foil 2 which was a current collector by the Doctor blade method so that the thickness after roll press was 160 μm, thereby forming cathode active material coated part 3. Cathode active material uncoated part 4 where no cathode active material was applied on either side was formed on both ends, and cathode conductive tab 6 was provided on one cathode active material uncoated part 4, and the adjacent region where the material was applied only on one side was formed to be cathode active material uncoated part 5 to give cathode 1.

Next, preparation of an anode is described with reference to FIG. 2.

In the present invention, graphite coated with amorphous carbon was prepared as follows. A graphite particle/phenolic resin mixed solution was prepared by immersing and dispersing 100 g of graphite particles in 150 g of a phenolic resin solution in methanol (VP-13N available from Hitachi Chemical Co., Ltd.; solid content adjusted to 15% by mass). Graphite particles coated with phenolic resin was produced by filtering and drying the solution. Subsequently, the graphite particles coated with phenolic resin was carbonized in nitrogen at 800° C. so as to carbonize the phenolic resin, thereby producing graphite particles coated with about 3% by mass of amorphous carbon.

An anode slurry was prepared by mixing 90% by mass of graphite coated with 3% by mass of amorphous carbon and 10% by mass of polyvinylidene fluoride which is a binder, adding N-methylpyrrolidone thereto and further mixing the mixture. The slurry was applied to both sides of 10 μm-thick Cu foil 8 which was a current collector so that the thickness after roll press was 120 μm and the electrode density was 1.50 g/cc, thereby forming anode active material coated part 9. On one of the both ends of the anode, anode active material coated part 10 where the anode active material was applied only on one side and anode active material uncoated part 11 where no anode active material was applied were formed, and anode conductive tab 12 was attached thereto to give anode 7.

Preparation of battery elements is described with reference to FIG. 3. Two separators 13 of a hydrophilized polypropylene porous film having a film thickness of 25 μm and a porosity of 55% were welded and cut, and the cut part was fixed on the winding core of a winding machine and wound up so as to introduce the tip of cathode 1 (FIG. 1) and anode 7 (FIG. 2). Anode 7 was interposed between the two separators with the connection of anode conductive tab 12 being the tip and cathode 1 was disposed on the separators with the other side of the connection of cathode conductive tab 6 being the tip, and they were wound by rotating the winding core to form a battery element (hereinafter referred to as jelly roll (J/R)).

The J/R was housed in an embossed laminate package and cathode conductive tab 6 and anode conductive tab 12 were pulled out; then one side of the laminate package was folded down, and the package was thermally fused with leaving a filling part.

Electrolyte was prepared by dissolving 0.7 mol/L LiTFSI (bis(trifluoromethanesulfonyl)imide lithium) in 1-methyl-1-propylpiperidinium bis(fluorosulfonyl)imide (MPPp-FSI).

The above electrolyte was poured through the laminate filling part left upon sealing and vacuum immersed, and the filling part was thermally fused to form a battery.

The discharge capacity when charging the resulting battery to a battery voltage of 4.2 V with CC-CV (charging conditions: CC current: 0.02 C, CV time: 5 hours, temperature: 20° C.) and then discharging at 0.02 C to a battery voltage of 3.0 V was defined as the initial capacity; the ratio of the resulting initial capacity to the design capacity is shown in Table 3.

The ratio of 0.1 C capacity to 0.02 C capacity at 20° C., as the rate characteristics of the resulting battery, is shown in Table 3.

The cycle test of the resulting battery was performed at 20° C. with CC-CV charge (highest voltage 4.2 V, current: 0.5 C, CV time: 1.5 hours) and CC discharge (lowest voltage: 3.0 V, current: 0.5 C). For percent capacity retention, the ratio of the discharge capacity at 400th cycle to the discharge capacity at the first cycle is shown in Table 3.

For the burning test, the battery after the cycle test was placed 10 cm above the tip of gas burner flame, and the evaporation and burning of the electrolyte solvent was evaluated as follows. Electrolyte not ignited: [symbol] ; ignited but extinguished in 2 to 3 seconds: ◯; ignited but extinguished within 10 seconds: Δ; not extinguished, kept burning: x. The results are shown in Table 3.

### Example 2

Example 2 was carried out in the same manner as in Example 1 except for using graphite coated with amorphous carbon (coating amount of amorphous carbon being about 10% by mass) in the same manner as in Example 1 by using a phenolic resin solution in methanol having a solid content of 50% by mass.

### Example 3

Example 3 was carried out in the same manner as in Example 1 except for using graphite coated with amorphous carbon in the same manner as in Example 1 (coating amount of amorphous carbon being about 15% by mass) by immersing and dispersing 100 g of graphite carbon in 230 g of a phenolic resin solution in methanol having a solid content of 50% by mass.

### Example 4

Example 4 was carried out in the same manner as in Example 1 except for using graphite coated with amorphous carbon in the same manner as in Example 1 (coating amount of amorphous carbon being about 20% by mass) by immersing and dispersing 100 g of graphite carbon in 300 g of a phenolic resin solution in methanol having a solid content of 50% by mass.

### Example 5

Example 5 was carried out in the same manner as in Example 1 except for using graphite coated with amorphous carbon in the same manner as in Example 1 (coating amount of amorphous carbon being about 30% by mass) by immersing and dispersing 100 g of graphite carbon in 300 g of a phenolic resin solution in methanol having a solid content of 70% by mass.

### Example 6

Example 0.6 was carried out in the same manner as in Example 2 except for using 1-methyl-1-propylpyrrolidinium bis(fluorosulfonyl)imide (MPP-FSI) as ionic liquid.

### Example 7

Example 7 was carried out in the same manner as in Example 2 except for adding 2% by mass of a compound represented by formula 3 shown in Table 1 to electrolyte as disulfonic acid ester.

### Example 8

Example 8 was carried out in the same manner as in Example 2 except for further adding 2% by mass of vinylene carbonate to electrolyte.

### Comparative Example 1

Comparative Example 1 was carried out in the same manner as in Example 1 except for using natural graphite alone which was not coated with amorphous carbon as an anode active material.

### Comparative Example 2

Comparative Example 2 was carried out in the same manner as in Example 7 except for using natural graphite alone which was not coated with amorphous carbon as an anode active material.

### Comparative Example 3

Comparative Example 3 was carried out in the same manner as in Example 8 except for using natural graphite alone which was not coated with amorphous carbon as an anode active material.

TABLE 3

| | | Coating | | | | Rate | | |
|---|---|---|---|---|---|---|---|---|
| | | amount of | | | Initial | characteristics (%) | Percent capacity | |
| | Anode active | amorphous | Ionic | | capacity | @0.1C/0.02C | retention (%) | Flamma- |
| | material | carbon | liquid | Additive | (%) | capacity | @ 400cycles | bility |
| Example 1 | graphite | 3% by mass | MPPp-FSI | — | 90 | 80 | 73 | ⊚ |
| | coated with | | | | | | | |
| | amorphous | | | | | | | |
| | carbon | | | | | | | |
| Example 2 | graphite | 10% by mass | MPPp-FSI | — | 90 | 83 | 78 | ⊚ |
| | coated with | | | | | | | |
| | amorphous | | | | | | | |
| | carbon | | | | | | | |
| Example 3 | graphite | 15% by mass | MPPp-FSI | — | 89 | 84 | 82 | ⊚ |
| | coated with | | | | | | | |
| | amorphous | | | | | | | |
| | carbon | | | | | | | |
| Example 4 | graphite | 20% by mass | MPPp-FSI | — | 85 | 86 | 83 | ⊚ |
| | coated with | | | | | | | |
| | amorphous | | | | | | | |
| | carbon | | | | | | | |
| Example 5 | graphite | 30% by mass | MPPp-FSI | — | 79 | 87 | 83 | ⊚ |
| | coated with | | | | | | | |
| | amorphous | | | | | | | |
| | carbon | | | | | | | |
| Example 6 | graphite | 10% by mass | MPP-FSI | — | 88 | 88 | 77 | ⊚ |
| | coated with | | | | | | | |
| | amorphous | | | | | | | |
| | carbon | | | | | | | |
| Example 7 | graphite | 10% by mass | MPPp-FSI | disulfonic acid | 86 | 81 | 84 | ⊚ |
| | coated with | | | ester 2% | | | | |
| | amorphous | | | | | | | |
| | carbon | | | | | | | |
| Example 8 | graphite | 10% by mass | MPPp-FSI | disulfonic acid | 85 | 79 | 86 | ⊚ |
| | coated with | | | ester 2% + VC 2% | | | | |
| | amorphous | | | | | | | |
| | carbon | | | | | | | |
| Comparative | graphite | — | MPPp-FSI | — | 71 | 73 | 26 | Δ |
| Example 1 | | | | | | | | |
| Comparative | graphite | — | MPPp-FSI | disulfonic acid | 78 | 69 | 68 | Δ |
| Example 2 | | | | ester 2% | | | | |
| Comparative | graphite | — | MPPp-FSI | disulfonic acid | 78 | 66 | 71 | ◯ |
| Example 3 | | | | ester 2% + VC 2% | | | | |

Results of Examples 1 to 8 and Comparative Examples 1 to 3 are summarized in Table 3. As shown in Comparative Example 1 and Examples 1 to 3, with an increase in the coating amount of amorphous carbon up to about 10 to 15% by mass, the initial capacity increased based on the design capacity, the irreversible capacity decreased and the percent cycle capacity retention also increased. Also, when the amount of amorphous carbon was increased to 30% by mass, the irreversible capacity increased and the initial capacity decreased, but the percent cycle capacity retention was excellent and the rate characteristics were improved. In other words, coating graphite with amorphous carbon has made it possible to suppress reduction and decomposition on graphite, and as a result, the capacity increased and also the percent cycle capacity retention was improved.

Example 6 has proved that similar effects were seen even with a different ionic liquid.

Examples 7, 8 and Comparative Examples 2, 3 show that although flame retardancy cannot be maintained with graphite when the amount of the additive is the same as in Examples 7 and 8, the capacity and the percent cycle capacity retention were further improved and the effect of maintaining flame retardancy was seen in Examples 7 and 8.

### Example 9

Example 9 was carried out in the same manner as in Example 7 except for using gel electrolyte instead of the electrolyte in Example 7. A pre-gel solution was prepared by adding, to an electrolyte prepared by mixing an ionic liquid, MPPp-FSI, and 0.7 mol/L LiTFSI which is a lithium salt, 2% by mass of compound No. 3, 3.8% by mass of triethylene glycol diacrylate and 1% by mass of trimethylolpropane triacrylate, which are gelling agents, and sufficiently mixing the resultant, and then adding 0.5% by mass of t-butyl peroxypivalate which is a polymerization initiator.

Subsequently, the pre-gel solution was poured through the filling part and vacuum immersed, and polymerization was performed at 80° C. for 2 hours to produce a lithium ion battery (lithium polymer battery).

### Comparative Example 4

Comparative Example 4 was carried out in the same manner as in Example 9 except for using graphite instead of the carbon in Example 9.

Results of measuring the initial capacity and other characteristics in Example 9 and Comparative Example 4 are shown in Table 4.

TABLE 4

| | | Coating | | | | Rate | | |
|---|---|---|---|---|---|---|---|---|
| | | amount of | | | Initial | characteristics (%) | Percent capacity | |
| | Anode active | amorphous | Ionic | | capacity | @0.1 C/0.02C | retention (%) | Flamma- |
| | material | carbon | liquid | Additive | (%) | capacity | @ 400cycles | bility |
| Example 9 | graphite | 10% by mass | MPPp-FSI | disulfonic acid | 84 | 75 | 82 | ⊚ |
| | coated with | | | ester 2% | | | | |
| | amorphous | | | | | | | |
| | carbon | | | | | | | |
| Comparative | graphite | — | MPPp-FSI | disulfonic acid | 70 | 56 | 67 | Δ |
| Example 4 | | | | ester 2% | | | | |

The effect of coating of amorphous carbon was also seen in the lithium polymer battery and the battery had good capacity, percent cycle capacity retention and flame retardancy.

As described above, the present invention makes it possible to provide a battery with high energy density, long term cycle properties, high-temperature storage characteristics, safety and improved rate characteristics.

What is claimed is:

1. A lithium ion battery comprising an electrolyte containing at least an ionic liquid composed of a bis(fluorosulfonyl)imide anion and a lithium salt, a cathode and an anode, wherein an anode active material is formed by coating the surface of graphite particles with an amorphous carbon or depositing an amorphous carbon thereonto.

2. The lithium ion battery according to claim 1, wherein the amorphous carbon with which the surface of the graphite particles is coated or which is deposited thereonto has an amount of 1% by mass or more to 30% by mass or less based on the anode active material.

3. The lithium ion battery according to claim 1, wherein the graphite particles have an interlayer distance between (002) planes of 0.335 to 0.337 nm.

4. The lithium ion battery according to claim 1, wherein the graphite particles are of natural graphite.

5. The lithium ion battery according to claim 1, wherein the anode active material has a specific surface area of 1.0 to 1.8 m²/g.

6. The lithium ion battery according to claim 1, wherein the electrolyte comprises disulfonic acid ester.

7. The lithium ion battery according to claim 6, wherein the electrolyte further comprises vinylene carbonate or a derivative thereof.

8. The lithium ion battery according to claim 1, wherein the electrolyte is gelled by a polymer.
